(19) United States
(12) Patent Application Publication
(10) Pub. No.: US 2012/0150412 A1
(43) Pub. Date: Jun. 14, 2012

(54) DRIVING WORK LOAD MEASUREMENT APPARATUS AND METHOD

(75) Inventors: Dae-Sub YOON, Daejeon (KR); Yoon-Sook HWANG, Gyeongbuk (KR); Kyong-Ho KIM, Daejeon (KR); Jong-Woo CHOI, Daejeon (KR); Hye-Sun PARK, Daegu (KR); Hyun-Suk KIM, Daejeon (KR); Jong-Hyun PARK, Daejeon (KR)

(73) Assignee: Electronics and Telecommunications Research Institute, Daejeon-city (KR)

(21) Appl. No.: 13/325,640

(22) Filed: Dec. 14, 2011

(30) Foreign Application Priority Data
Dec. 14, 2010 (KR) 10-2010-0127825

(51) Int. Cl. G06F 7/00; G06F 19/00

(52) U.S. Cl. 701/99; 701/1

(57) ABSTRACT

Disclosed herein is a driving work load measurement apparatus. The driving work load measurement apparatus includes a driving work load calculation unit and a warning alarm unit. The driving work load calculation unit calculates driving work loads driving-related information collected according to driving, and calculates a total driving work load using the driving work loads and weights which are set for the respective driving work loads. The warning alarm unit provides a warning message corresponding to the total driving work load, based on control of the driving work load calculation unit.

### CROSS REFERENCE TO RELATED APPLICATION

This application claims the benefit of Korean Patent Application No. 10-2010-0127825, filed on Dec. 14, 2010, which is hereby incorporated by reference in its entirety into this application.

### BACKGROUND OF THE INVENTION

1. Technical Field

The present invention relates generally to a driving work load measurement apparatus and method, and, more particularly, to a driving work load measurement apparatus and method, which applies weights to respective driving work loads, thereby objectively measuring a total driving work load.

2. Description of the Related Art

Although a driving work load that is felt by a driver is an important element which should be measured for the purpose of safe driving, it is difficult to objectively measure the driving work load because the driving work load is measured based on a uniform reference.

For example, with regard to an exiting traffic system, the degree of safe driving is measured in such a way that the speed based on road design reference is compared with the current speed of a vehicle and then it is determined whether the driver is driving too fast. The proper reference speed for a road may vary depending on the details of the road and is closely related to the average speed of travel on the road. However, the reference speed has until now been determined in a general way based on the law while differences in road structure have not been taken into consideration in detail.

Further, the degree of safe driving has been measured based on whether the driver dozes off while driving. That is, the case where a driver dozes off while driving has been determined as being dangerous driving, and the case where the driver does not doze off while driving has been determined as safe driving. In this case, the results are too extreme, so that there is a problem of decreasing accuracy because the degree of safe driving is measured only based on whether a driver dozed off while driving, whether the driver drove under the influence, and whether the driver used a cell phone while driving.

### SUMMARY OF THE INVENTION

Accordingly, the present invention has been made keeping in mind the above problems occurring in the prior art, and an object of the present invention is to provide a driving work load measurement apparatus and method, which uses driving work load measurement information to which weights are applied, thereby objectively measuring a total driving work load.

In order to accomplish the above object, the present invention provides a driving work load measurement apparatus, including: a driving work load calculation unit for calculating driving work loads using driving-related information collected according to driving, and calculating a total driving work load using the driving work loads and weights which are set for the respective driving work loads; and a warning alarm unit for providing a warning message correspond to the total driving work load, based on the control of the driving work load calculation unit.

The driving-related information may include vehicle movement information, environmental information, driving behavior information, driver's personal information, and survey information.

The driving work load calculation unit may calculate a first driving work load, felt by a driver, based on the vehicle movement information, calculate a second driving work load, felt by the driver, based on the environmental information, calculate a third driving work load, felt by the driver, based on the driving behavior information, calculate a fourth driving work load, felt by the driver, based on the driver's personal information, and calculate a fifth driving work load, felt by the driver, based on the survey information.

The driving work load calculation unit may calculate a current driving work load felt by the driver, adding the first to fifth driving work loads are added together.

The driving work load calculation unit may multiply the first to fifth driving work loads by first to fifth weights correspond to the first to fifth driving work loads respectively, and adds results of the multiplication respectively, and calculates the total driving work load based on results of adding the current driving work load and result of the addition.

The driving work load measurement apparatus may further include a movement information sensing unit for collecting vehicle movement information and generating a vehicle movement information table.

The vehicle movement information table may include a speed field indicative of speed information, a Revolutions Per Minute (RPM) field indicative of RPM information, a steering angle field indicative of steering angle information, a brake pedal field indicative of brake pedal value information, an accelerator pedal field indicative of accelerator pedal value information, and an engine status field indicative of engine status.

The driving work load measurement apparatus may further include an environmental information sensing unit for measuring environmental information during driving, and for generating an environmental information table.

The environmental information table may include a weather field indicative of weather information, a road status field indicative of road status, a road surface status field indicative of road surface status, and a vehicle location field indicative of a vehicle location.

The driving work load measurement apparatus may further include a driving behavior sensing unit for collecting driver's driving behavior information, and generating a driving behavior table.

The driving behavior table may include a right indicator light display field indicative of the on/off status of a right indicator light, a left indicator light display field indicative of the on/off status of a left indicator light, a steering field indicative of the start of a steering, a brake pedal operation field indicative of the operation of a brake pedal, and an accelerator pedal operation field indicative of the operation of an accelerator pedal.

The driving work load measurement apparatus may further include a driver information input unit for collecting the driver's personal information, and generating a driver information table.

The driver information table may include an Identification (ID) field indicative of a driver ID, an age field indicative of an age, a sex field indicative of a sex, a mileage field indicative of annual mileage, and an experience field indicative of driving experience.

The driving work load measurement apparatus may further include a survey input unit for collecting survey information, and generating a survey information table.

The survey information table may include a visual demand field indicative of visual demand, an auditory demand field indicative of auditory demand, a cognition demand field indicative of cognition demand, and a psychomotor demand field indicative of psychomotor demand.

In order to accomplish the above object, the present invention provides a driving work load measurement method, including: collecting driving-related information according to driving;

calculating driving work loads using driving-related information respectively; calculating a total driving work load using the driving work loads and weights which are set for the respective driving work loads; and providing a warning message based on a result of comparing the total driving work load with a threshold work load.

The driving-related information may include vehicle movement information, environmental information, driving behavior information, driver's personal information, and survey information.

The calculating the driving work load may include: calculating a first driving work load, felt by the driver, based on the vehicle movement information; calculating a second driving work load, felt by the driver, based on the environmental information; calculating a third driving work load, felt by the driver, based on the driving behavior information; calculating a fourth driving work load, felt by the driver, based on the driver's personal information; and calculating a fifth driving work load, felt by the driver, based on the survey information.

The calculating the total driving work load may include: calculating a current driving work load felt by the driver, adding the first to fifth driving work loads; multiplying the first to fifth driving work loads by first to fifth weights correspond to the first to fifth driving work loads respectively; adding results of the multiplication respectively; and calculating the total driving work load based on results of adding the current driving work load and result of a addition.

The providing the warning message may include providing the warning message generated previously correspond to the total driving work load when the total driving work load is greater than the threshold work load.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view schematically illustrating a driving work load measurement apparatus according to an embodiment of the present invention;

FIG. 2 is a view illustrating an example of a vehicle movement information table generated using the movement information sensing unit of the driving work load measurement apparatus of FIG. 1;

FIG. 3 is a view illustrating an example of an environmental information table generated using the environmental information sensing unit of the driving work load measurement apparatus of FIG. 1;

FIG. 4 is a view illustrating an example of a driving behavior table generated using the driving behavior sensing unit of the driving work load measurement apparatus of FIG. 1;

FIG. 5 is a view illustrating an example of a driver information table generated using the driver information input unit of the driving work load measurement apparatus of FIG. 1;

FIG. 6 is a view illustrating an example of a survey information table generated using the survey input unit of the driving work load measurement apparatus of FIG. 1; and

FIG. 7 is a flowchart illustrating the flow in which the driving work load measurement apparatus of FIG. 1 measures the driving work load.

### DESCRIPTION OF THE PREFERRED EMBODIMENTS

Embodiments of the present invention will be described in detail with reference to the accompanying drawings below. Here, when repeated description and detailed descriptions of well-known functions or configurations may unnecessarily obscure the gist of the present invention, the detailed descriptions will be omitted. The embodiments of the present invention are also provided to completely explain to those skilled in the art the present invention. Therefore, the shapes and sizes of components in the drawings may be exaggerated for the sake of a more exact description.

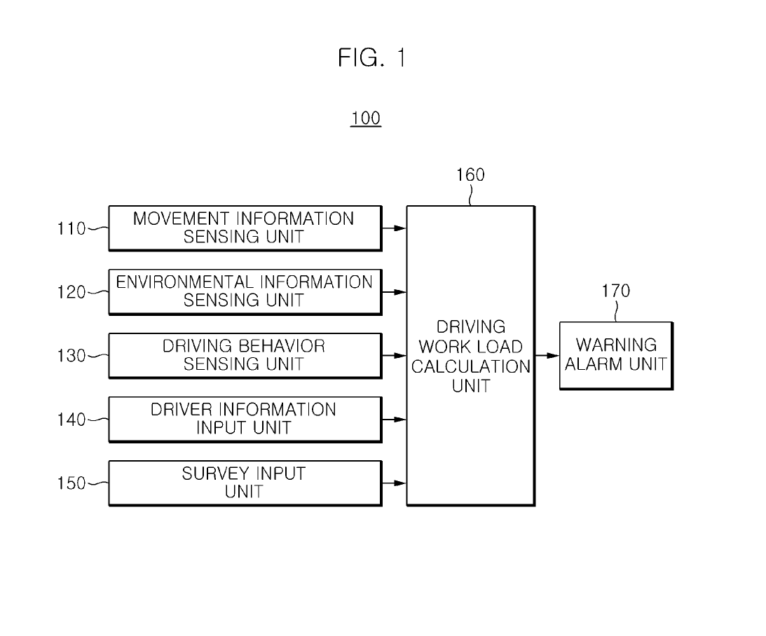

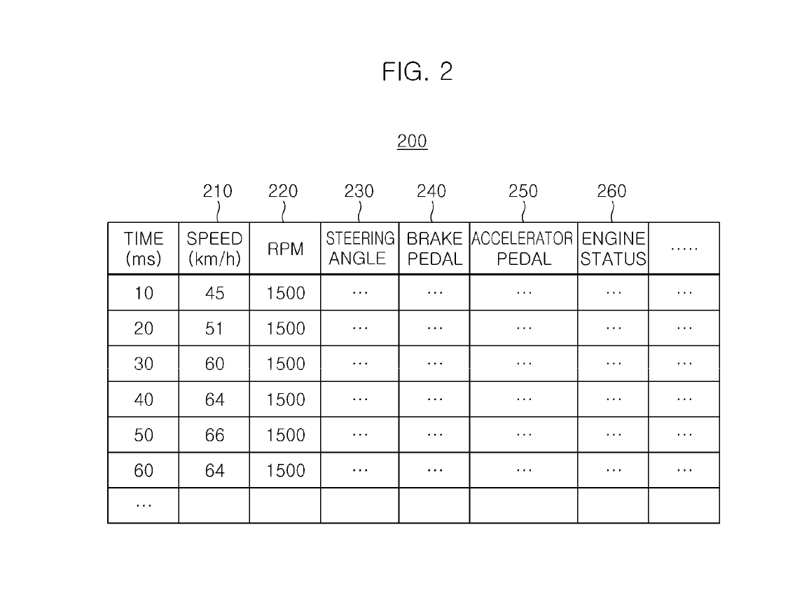

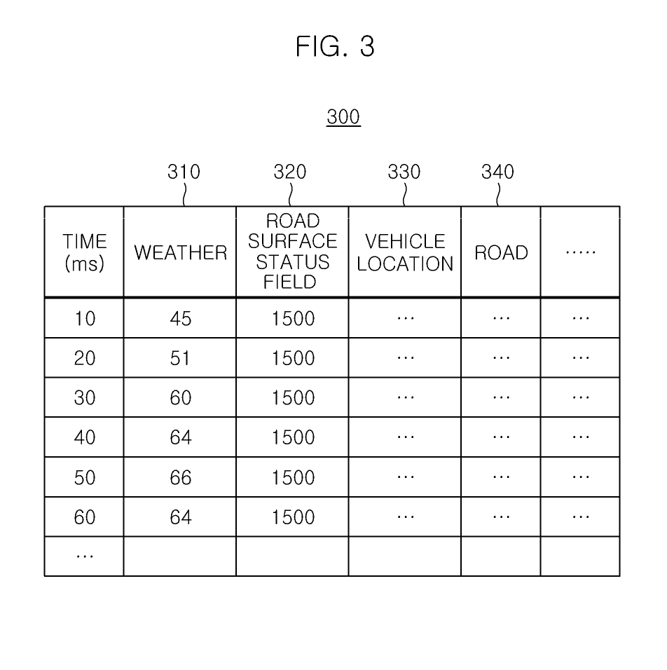

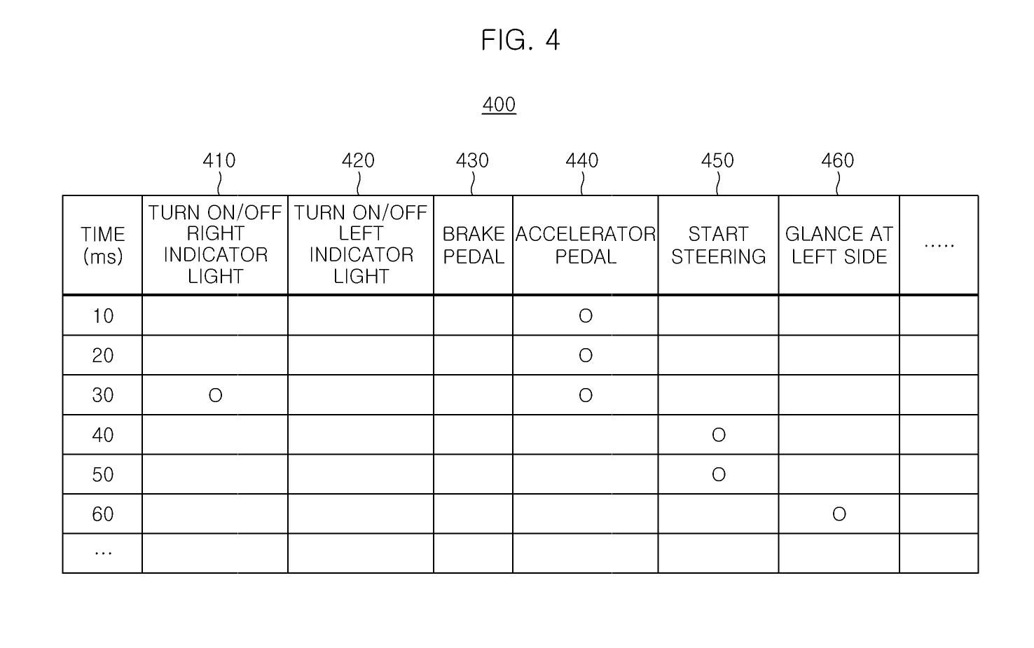

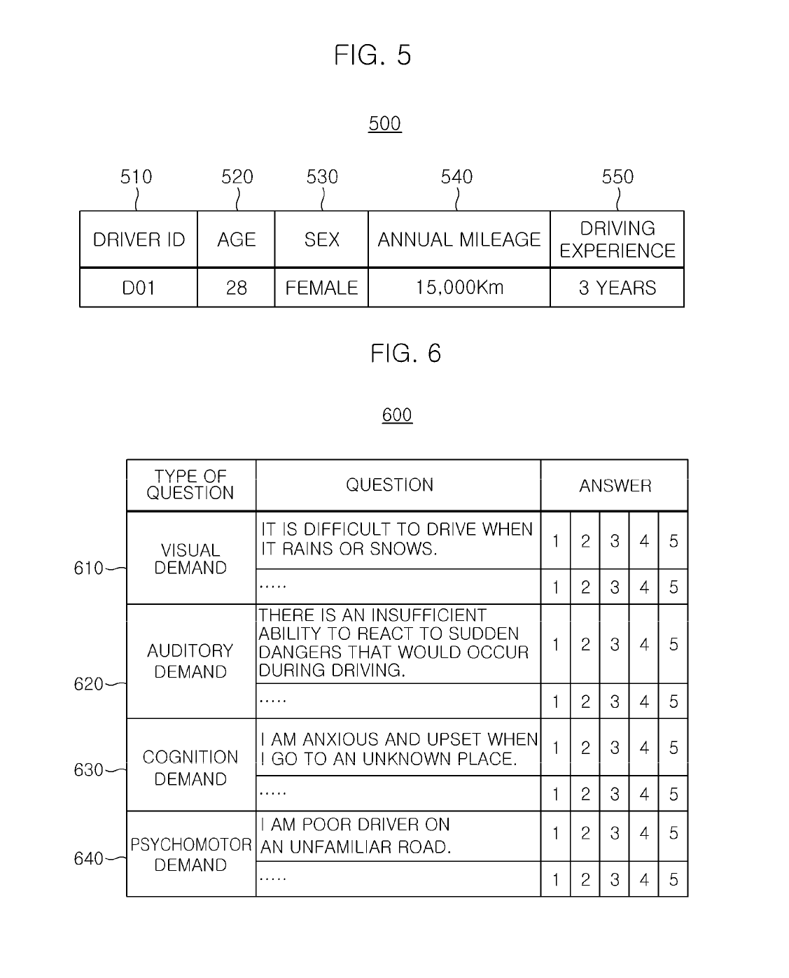

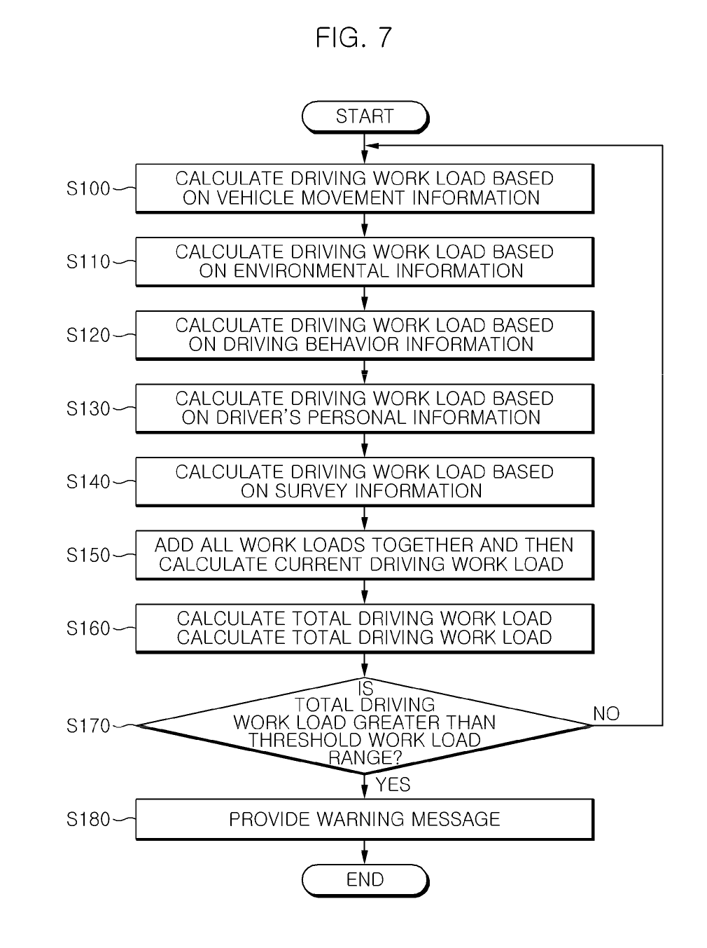

FIG. 1 is a view schematically illustrating a driving work load measurement apparatus according to an embodiment of the present invention. FIG. 2 is a view illustrating an example of a vehicle movement information table generated using the movement information sensing unit of the driving work load measurement apparatus of FIG. 1. FIG. 3 is a view illustrating an example of an environmental information table generated using the environmental information sensing unit of the driving work load measurement apparatus of FIG. 1. FIG. 4 is a view illustrating an example of a driving behavior table generated using the driving behavior sensing unit of the driving work load measurement apparatus of FIG. 1. FIG. 5 is a view illustrating an example of a driver information table generated using the driver information input unit of the driving work load measurement apparatus of FIG. 1. FIG. 6 is a view illustrating an example of a survey information table generated using the survey input unit of the driving work load measurement apparatus of FIG. 1. FIG. 7 is a flowchart illustrating the flow in which the driving work load measurement apparatus of FIG. 1 measures the driving work load.

As shown in FIG. 1, a driving work load measurement apparatus 100 for measuring a driving work load according to the present invention collects driving-related information when a driver is traveling, and calculates a total driving work load using the driving-related information. Here, the driving-related information may include vehicle movement information, environmental information, driving behavior information, driver's personal information, and survey information. Although the embodiment of the present invention has been described to the effect that the driving-related information includes the vehicle movement information, the environmental information, the driving behavior information, the driver's personal information, and the survey information, the present invention is not limited thereto. Various types of information which are necessary to calculate the total driving work load may be included in the driving-related information.

The driving work load measurement apparatus 100 includes a movement information sensing unit 110, an environmental information sensing unit 120, a driving behavior sensing unit 130, a driver information input unit 140, a survey input unit 150, a driving work load calculation unit 160, and a warning alarm unit 170.

The movement information sensing unit 110 is used to collect vehicle movement information which can be measured in a vehicle while a driver is traveling, and then to generate a vehicle movement information table 200. Here, the vehicle movement information may include speed, Revolutions Per Minute (RPM), a steering angle, brake pedal value information, accelerator pedal value information, and engine status.

In detail, as shown in FIG. 2, the vehicle movement information table 200 includes a speed field 210 indicative of “speed information”, an RPM field 220 indicative of “RPM”, a steering angle field 230 indicative of a “steering angle”, a brake pedal field 240 indicative of “brake pedal value information”, an accelerator pedal field 250 indicative of “accelerator pedal value information”, and engine status field 260 indicative of “engine status”. Here, the steering angle indicates an angle in which the spin of a steering wheel performs rotational movement when the direction of a vehicle changes.

The environmental information sensing unit 120 measures environmental information, when a driver is traveling, using image sensors and Global Positioning System (GPS) information, and then generates an environmental information table 300. Here, the environmental information may include weather, road status, road surface status, and the vehicle location.

In particular, as shown in FIG. 3, the environmental information table 300 includes a weather field 310 indicative of “weather information”, a road status field 320 indicative of “road status”, a road surface status field 330 indicative of “road surface status”, and a vehicle location field 340 indicative of the “vehicle location”.

The driving behavior sensing unit 130 collects driver's driving behavior information by determining information recorded inside of the vehicle or by using image sensors (not shown) which are separately installed, tracks the eyes of a driver using an eye tracking apparatus (not shown), and then generates a driving behavior table 400. Here, the driving behavior information may include a right indicator light turning-on action, a left indicator light turning-on action, a brake pedal pressing action, an accelerator pedal pressing action, a right-side steering starting action, and a left side glance action.

In particular, as shown in FIG. 4, the driving behavior sensing unit 130 determines the right indicator light turning on/off action, the left indicator light turning on or turning off action, and the steering starting action using information about the use of the arms of the driver, and then displays the results of the determination in a right indicator light display field 410, a left indicator light display field 420, and a steering field 450. The driving behavior sensing unit 130 determines the brake pedal pressing action and an accelerator pedal pressing action using information about the use of the feet of the driver, and then displays the results of the determination in a brake pedal pressing action field 430 and an accelerator pedal pressing action field 440. The driving behavior sensing unit 130 determines whether the driver performed a left side glance action using information obtained by tracking the eyes of the driver when the driver is traveling, and then displays the result of the determination in a left side glance field. 450.

The driver information input unit 140 collects driver's personal information and driving experience information, and then generates a driver information table 500. Here, the driver's personal information may include the IDentifier (ID), age, sex, annual mileage, and driving experience of a driver.

In detail, as shown in FIG. 5, driver information table 500 includes an ID field 510 indicative of a “driver ID”, an age field 520 indicative of “age”, a sex field 530 indicative of “sex”, a mileage field 540 indicative of “annual mileage” and an experience field 550 indicative of “driving experience”.

Referring to FIG. 1 again, the survey input unit 150 collects survey information in order to determine the situations with which a driver is burdened when the driver is traveling, and then generates a survey information table 600. Here, the survey information may include a visual demand, an auditory demand, a cognition demand, and a psychomotor demand.

In detail, as shown in FIG. 6, the survey information table 600 includes a visual demand field 610 indicative of “visual demand”, an auditory demand field 620 indicative of “auditory demand”, a cognition demand field 630 indicative of “cognition demand”, and a psychomotor demand field 640 indicative of “psychomotor demand”. For example, with regard to the “visual demand”, the question of whether “it is difficult to drive when it rains or snows” is asked and the response thereto is collected. With regard to the “auditory demand”, the question of whether “there is an insufficient ability to react to sudden dangers that would occur during driving” is asked and the response thereto is collected. With regard to the “cognition demand”, the question of whether “I am anxious and upset when I go to an unknown place” is asked and the response thereto is collected. With regard to the “psychomotor demand”, the question of whether “I am poor driver on an unfamiliar road” is asked and the response thereto is collected.

The driving work load calculation unit 160 calculates a total driving work load CWL based on the content displayed in the respective tables generated using the environmental information sensing unit 120, the driving behavior sensing unit 130, the driver information input unit 140, and the survey input unit 150.

In particular, the driving work load calculation unit 160 calculates a driving work load DdataWL, felt by a driver, based on the “vehicle movement information Ddata” of the vehicle movement information table 200. Further, the driving work load calculation unit 160 calculates a driving work load EdataWL, felt by the driver, based on the “environmental information Edata” of the environmental information table 300. The driving work load calculation unit 160 calculates a driving work load BdataWL according to the behavior of the current driver based on the “driving behavior information Bdata” of the driving behavior information table 400. The driving work load calculation unit 160 calculates a basic driving work load HdataWL according to the body condition and experience of the driver based on the “driver's personal information Hdata” of the driver information table 500. The driving work load calculation unit 160 calculates a driving work load SdataWL according to the content of the survey based on the “survey information SdataWL” of the survey information table 600.

The driving work load calculation unit 160 adds the driving work loads DdataWL, EdataWL, BdataWL, HdataWL, and SdataWL, thereby calculating a current driving work load (CWL1) that is currently felt by the driver.

Further, the driving work load calculation unit 160 multiplies the driving work loads DdataWL, EdataWL, BdataWL, HdataWL, and SdataWL by respective weights k1, k2, k3, k4, and k5, which are set such that they correspond to the respective driving work loads, and generates a weighted sum by adding the results of the multiplication together, and then adds the weighted sum to the current driving work load CWL1, thereby calculating the total driving work load CWL. The total driving work load CWL is expressed in Equation 1. The respective weights according to the embodiment of the present invention are experimental values which were set after various experiments had been performed to know the substantial effect of each of the driving work loads on the driver. The content of a warning message may vary depending on the given weight which is used to calculate the total driving work load.

The total driving work load CWL=current driving work load (CWL1)+k1*DdataWL+k2*EdataWL+k3*BdataWL+k4*HdataWL+k5*SdataWL (1)

The driving work load calculation unit 160 controls the warning alarm unit 170 such that a warning message may be generated for a driver based on the result of comparing the total driving work load CWL with a set threshold work load TWL.

The warning alarm unit 170 generates a warning message based on the control of the driving work load calculation unit 160, and then transmits the generated warning message to the driver. The warning message according to the embodiment of the present invention is previously set so as to correspond to the total driving work load CWL based on the variation in the weights. Here, the warning message may be provided in various forms, such as a simple alarm and an announcement requesting that a driver should take a break, based on the driving environment.

FIG. 7 is a flowchart illustrating the flow in which the driving work load measurement apparatus shown in FIG. 1 measures the driving work load.

As shown in FIG. 7, the driving work load calculation unit 160 of the driving work load measurement apparatus 100 for measuring a driving work load according to the present invention receives “vehicle movement information Ddata” from the vehicle movement information table 200, which is stored in the movement information sensing unit 110, and then calculates the driving work load DdataWL, felt by the driver, based on the “vehicle movement information Ddata” at step S100.

The driving work load calculation unit 160 receives “environmental information Edata” which is stored in the environmental information table 300, and calculates a driving work load EdataWL, felt by the driver, based on the “environmental information Edata” at step S110.

The driving work load calculation unit 160 receives “driving behavior information Bdata” which is stored in the driving behavior information table 400, and then calculates a driving work load BdataWL according to the behavior of the current driver based on the “driving behavior information Bdata” at step S120.

The driving work load calculation unit 160 receives the “driver's personal information Hdata” which is stored in the driver information table 500, and then calculates a driving work load HdataWL according to the body condition and experience of the driver based on the “driver's personal information Hdata” at step S130.

The driving work load calculation unit 160 receives “survey information SdataWL” stored in the survey information table 600, and then calculates the work load SdataWL according to survey content based on the “survey information SdataWL” at step S140.

The driving work load calculation unit 160 calculates a current driving work load CWL1, currently being felt by the driver, by adding the driving work loads DdataWL, EdataWL, BdataWL, HdataWL, and SdataWL, at step S150.

The driving work load calculation unit 160 multiplies the driving work loads DdataWL, EdataWL, BdataWL, HdataWL and SdataWL by respective weights k1, k2, k3, k4, and k5, adds the respective results of the multiplication, and adds the result of the addition to the current driving work load CWL1, thereby calculating the total driving work load CWL (refer to Equation 1) at step S160.

The driving work load calculation unit 160 compares the total driving work load CWL with a set threshold work load TWL at step S170.

If, as the result of the determination at step S170, the total driving work load CWL is greater than the set threshold work load TWL, the driving work load calculation unit 160 determines that the driver feels a work load which is greater than the threshold and that a warning message is necessary. The driving work load calculation unit 160 controls the warning alarm unit 170 such that a warning message, which correspond to the total driving work load CWL and was previously generated, is provided to the driver at step S180.

If, as the result of the determination at step S170, the total driving work load CWL is smaller than the set threshold work load TWL, the driving work load calculation unit 160 determines that the driver does not feel a work load which is greater than the threshold, returns to step S100, and repeats the process.

As described above, the driving work load measurement apparatus according to the present invention calculates the total driving work load in such a way as to calculate driving work loads for the respective pieces of “vehicle movement information”, “environmental information”, “driving behavior information”, “driver's personal information”, and “survey information” and then to apply weights which have been previously set for the respective driving work loads, so that there are advantages of objectively measuring and providing the current driving work load status of a driver, and safely protecting the driver in dangerous situations by providing a warning message based on the driving work load status.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A driving work load measurement apparatus, comprising:
a driving work load calculation unit for calculating driving work loads using driving-related information collected according to driving, and calculating a total driving work load using the driving work loads and weights which are set for the respective driving work loads; and
a warning alarm unit for providing a warning message corresponding to the total driving work load, based on control of the driving work load calculation unit.

2. The driving work load measurement apparatus as set forth in claim 1, wherein the driving-related information comprises vehicle movement information, environmental information, driving behavior information, driver's personal information, and survey information.

3. The driving work load measurement apparatus as set forth in claim 2, wherein the driving work load calculation unit calculates a first driving work load, felt by a driver, based on the vehicle movement information, calculates a second driving work load, felt by the driver, based on the environmental information, calculates a third driving work load, felt by the driver, based on the driving behavior information, calculates a fourth driving work load, felt by the driver, based on the driver's personal information, and calculates a fifth driving work load, felt by the driver, based on the survey information.

4. The driving work load measurement apparatus as set forth in claim 3, wherein the driving work load calculation unit calculates a current driving work load felt by the driver, adding the first to fifth driving work loads.

5. The driving work load measurement apparatus as set forth in claim 4, wherein the driving work load calculation unit multiplies the first to fifth driving work loads by first to fifth weights corresponding to the first to fifth driving work loads respectively, and generates a weighted sum by adding results of the multiplication, and calculates the total driving work load by adding the current driving work load and the weighted sum.

6. The driving work load measurement apparatus as set forth in claim 1, further comprising a movement information sensing unit for collecting vehicle movement information and generating a vehicle movement information table.

7. The driving work load measurement apparatus as set forth in claim 6, wherein the vehicle movement information table comprises a speed field indicative of speed information, a Revolutions Per Minute (RPM) field indicative of RPM information, a steering angle field indicative of steering angle information, a brake pedal field indicative of brake pedal value information, an accelerator pedal field indicative of accelerator pedal value information, and an engine status field indicative of engine status.

8. The driving work load measurement apparatus as set forth in claim 1, further comprising an environmental information sensing unit for measuring environmental information during driving, and generating an environmental information table.

9. The driving work load measurement apparatus as set forth in claim 8, wherein the environmental information table comprises a weather field indicative of weather information, a road status field indicative of road status, a road surface status field indicative of road surface status, and a vehicle location field indicative of a vehicle location.

10. The driving work load measurement apparatus as set forth in claim 1, further comprising a driving behavior sensing unit for collecting driver's driving behavior information, and generating a driving behavior table.

11. The driving work load measurement apparatus as set forth in claim 10, wherein the driving behavior table comprises a right indicator light display field indicative of an on/off status of a right indicator light, a left indicator light display field indicative of an on/off status of a left indicator light, a steering field indicative of start of a steering, a brake pedal operation field indicative of an operation of a brake pedal, and an accelerator pedal operation field indicative of an operation of an accelerator pedal.

12. The driving work load measurement apparatus as set forth in claim 1, further comprising a driver information input unit for collecting the driver's personal information, and generating a driver information table.

13. The driving work load measurement apparatus as set forth in claim 12, wherein the driver information table comprises an Identification (ID) field indicative of a driver ID, an age field indicative of an age, a sex field indicative of a sex, a mileage field indicative of annual mileage, and an experience field indicative of driving experience.

14. The driving work load measurement apparatus as set forth in claim 1, further comprising a survey input unit for collecting survey information, and generating a survey information table.

15. The driving work load measurement apparatus as set forth in claim 14, wherein the survey information table comprises a visual demand field indicative of visual demand, an auditory demand field indicative of auditory demand, a cognition demand field indicative of cognition demand, and a psychomotor demand field indicative of psychomotor demand.

16. A driving work load measurement method, comprising:
collecting driving-related information according to driving;
calculating driving work loads using driving-related information respectively;
calculating a total driving work load using the driving work loads and weights which are set for the respective driving work loads; and
providing a warning message based on a result of comparing the total driving work load with a threshold work load.

17. The driving work load measurement method as set forth in claim 16, wherein the driving-related information comprises vehicle movement information, environmental information, driving behavior information, driver's personal information, and survey information.

18. The driving work load measurement method as set forth in claim 17, wherein the calculating the driving work load comprises:
calculating a first driving work load, felt by the driver, based on the vehicle movement information;
calculating a second driving work load, felt by the driver, based on the environmental information;
calculating a third driving work load, felt by the driver, based on the driving behavior information;
calculating a fourth driving work load, felt by the driver, based on the driver's personal information; and
calculating a fifth driving work load, felt by the driver, based on the survey information.

19. The driving work load measurement method as set forth in claim 18, wherein the calculating the total driving work load comprises:
calculating a current driving work load felt by the driver, adding the first to fifth driving work loads;
multiplying the first to fifth driving work loads by first to fifth weights corresponding to the first to fifth driving work loads respectively;
generating a weighted sum by adding results of the multiplication; and
calculating the total driving work load based on adding the current driving work load and the weighted sum.

20. The driving work load measurement method as set forth in claim 16, wherein the providing the warning message comprises providing the warning message generated previously correspond to the total driving work load when the total driving work load is greater than the threshold work load.
